(19) United States
(12) Patent Application Publication
(10) Pub. No.: US 2025/0280156 A1
(43) Pub. Date: Sep. 4, 2025

(54) ILLUMINATION COMPENSATION IN VIDEO CODING

(71) Applicants: Douyin Vision Co., Ltd., Beijing (CN); Bytedance Inc., Los Angeles, CA (US)

(72) Inventors: Bharath Vishwanath, San Diego, CA (US); Na Zhang, Beijing (CN); Kai Zhang, San Diego, CA (US); Li Zhang, San Diego, CA (US)

(21) Appl. No.: 19/210,039

(22) Filed: May 16, 2025

Related U.S. Application Data
(63) Continuation of application No. PCT/CN2023/131997, filed on Nov. 16, 2023.

(30) Foreign Application Priority Data
Nov. 16, 2022 (WO) PCT/CN2022/132234

(51) Int. Cl. H04N 19/90; H04N 19/105; H04N 19/176; H04N 19/184; H04N 19/52

(52) U.S. Cl. CPC H04N 19/90; H04N 19/105; H04N 19/176; H04N 19/184; H04N 19/52

(57) ABSTRACT

A mechanism for processing video data is disclosed. The mechanism includes determining to apply a multiple-parameter local illumination compensation (MPLIC) to a visual media data. MPLIC can be used as an additional local illumination compensation (LIC) mode or instead of LIC. A conversion is performed between the visual media data and a bitstream based on the MPLIC.

### CROSS-REFERENCE TO RELATED PATENT APPLICATIONS

This is a continuation of International Patent Application No. PCT/CN2023/131997, filed on Nov. 16, 2023, which claims the priority to and benefits of International Patent Application No. PCT/CN2022/132234, filed on Nov. 16, 2022. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining to apply a multiple-parameter local illumination compensation (MPLIC) to a visual media data; and performing a conversion between the visual media data and a bitstream based on the MPLIC.

A second aspect relates to an apparatus for processing video data comprising: a processor; and a non-transitory memory with instructions thereon, wherein the instructions upon execution by the processor, cause the processor to perform any of the preceding aspects.

A third aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining to apply a multiple-parameter local illumination compensation (MPLIC) to a visual media data; and generating the bitstream based on the determining.

A fifth aspect relates to a method for storing bitstream of a video comprising: determining to apply a multiple-parameter local illumination compensation (MPLIC) to a visual media data; generating the bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates example positions of a spatial merge candidate.

FIG. 2 illustrates example candidate pairs considered for redundancy check of spatial merge candidates.

FIG. 3 illustrates example candidate positions for temporal merge candidates.

FIG. 4 illustrates an example merge mode with motion vector difference (MMVD) search point.

FIG. 5 illustrates an example of symmetrical motion vector difference (MVD) mode.

FIG. 6 illustrates an example control point based affine motion model.

FIG. 7 illustrates an example affine motion vector field (MVF) per subblock.

FIG. 8 illustrates example locations of inherited affine motion predictors.

FIG. 9 illustrates an example of control point motion vector inheritance.

FIG. 10 illustrates example locations of candidate positions for constructed affine merge mode.

FIG. 11 illustrates an example of motion vector (MV) usage for a combined method.

FIG. 12 illustrates an example of a subblock MV VsB and pixel.

FIG. 13 illustrates an example of the subblock-based temporal motion vector prediction (sbTMVP) process in Versatile Video Coding (VVC).

FIG. 14 illustrates an example extended coding unit (CU) region used in bi-directional optical flow (BDOF).

FIG. 15 illustrates an example of decoder side motion vector refinement.

FIG. 16 illustrates an example of Geometric partitioning mode (GPM) splits grouped by identical angles.

FIG. 17 illustrates an example of uni-prediction MV selection for a geometric partitioning mode.

FIG. 18 illustrates an example of generation of a bending weight using geometric partitioning mode.

FIG. 19 illustrates an example of top and left neighboring blocks used in Combined inter and intra prediction (CIIP) weight derivation.

FIG. 20 illustrates an example of spatial neighboring blocks used to derive the spatial merge candidates.

FIG. 21 illustrates an example of template matching performed on a search area around an initial MV.

FIG. 22 illustrates an example of diamond regions in a search area.

FIG. 23 illustrates an example of frequency responses of an interpolation filter and a VVC interpolation filter at half-pel phase.

FIG. 24 illustrates an example of template and reference samples of a template in reference pictures.

FIG. 25 illustrates an example of template and reference samples of the template for a block with sub-block motion using the motion information of the subblocks of the current block.

FIG. 26 illustrates an example of virtual block generation for improved direct current (DC) prediction.

FIG. 27 is a block diagram showing an example video processing system.

FIG. 28 is a block diagram of an example video processing apparatus.

FIG. 29 is a flowchart for an example method of video processing.

FIG. 30 is a block diagram that illustrates an example video coding system.

FIG. 31 is a block diagram that illustrates an example encoder.

FIG. 32 is a block diagram that illustrates an example decoder.

FIG. 33 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the techniques described herein are applicable to other video codec protocols and designs.

### 1. Initial Discussion

This disclosure is related to video coding technologies. Specifically, it is related to inter prediction in video coding with an emphasis on sequences with illumination changes. The ideas may be applied individually or in various combinations to image/video coding standards and/or other image/video codecs, e.g., next-generation image/video coding standards.

### 2.1 Inter Prediction in VVC

For each inter-predicted CU, motion parameters including motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one prediction unit (PU) and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in High Efficiency Video Coding (HEVC), VVC includes a number of inter prediction coding tools listed as follows:
Extended merge prediction
High precision ( 1/16 pel) motion compensation and motion vector storage
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)
Reference picture resampling

The following text provides the details on those inter prediction methods specified in VVC.

### 2.1.1 Extended Merge Prediction

In VVC, the merge candidate list is constructed by including the following five types of candidates in order:
1) Spatial motion vector prediction (MVP) from spatial neighbour CUs
2) Temporal MVP from collocated CUs
3) History-based MVP from a first in first out (FIFO) table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1.1 Spatial Candidates Derivation

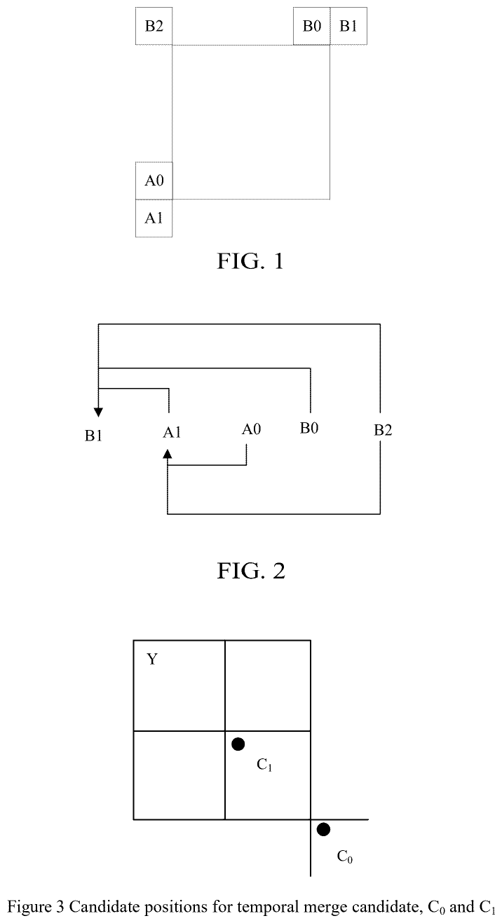

FIG. 1 illustrates example positions of a spatial merge candidate. FIG. 2 illustrates example candidate pairs considered for redundancy check of spatial merge candidates. The derivation of spatial merge candidates in VVC is same to that in HEVC except the positions of first two merge candidates are swapped. A maximum of four merge candidates are selected among candidates located in the positions depicted in FIG. 1. The order of derivation is B0, A0, B1, A1 and B2. Position B2 is considered only when one or more than one CUs of position B0, A0, B1, A1 are not available (e.g., because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 2 are considered and a candidate is only added to the list if the corresponding candidate used for redundancy check has not the same motion information.

### 2.1.1.2 Temporal Candidates Derivation

FIG. 3 illustrates example candidate positions for temporal merge candidates including C₀ ad C₁. In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the lines inside and outside the largest rectangular box in FIG. 3, which is scaled from the motion vector of the co-located CU using the picture order count (POC) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 2. If CU at position C₀ is not available, is intra coded, or is outside of the current row of coding tree units (CTUs), position C₁ is used. Otherwise, position C₀ is used in the derivation of the temporal merge candidate.

### 2.1.1.3 History-Based Merge Candidates Derivation

The history-based MVP (HMVP) merge candidates are added to merge list after the spatial MVP and temporal motion vector prediction (TMVP). In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to Aᵢ and Bᵢ spatial candidates, respectively.
2. Once the total number of available merge candidates reaches the maximally allowed merge candidates minus 1, the merge candidate list construction process from HMVP is terminated.

### 2.1.1.4 Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### 2.1.1.5 Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)»Log2ParMrgLevel is greater than xCb»Log2ParMrgLevel and (yCb+cbHeight)»Log2ParMrgLevel is great than (yC»Log2ParMrgLevel) and where (xCb, yCb) is the top-left luma sample position of the current CU in the picture and (cbWidth, cbHeight) is the CU size. The MER size is selected at encoder side and signalled as log2_parallel_merge_level_minus2 in the sequence parameter set.

### 2.1.2 High Precision ( 1/16 Pel) Motion Compensation and Motion Vector Storage

VVC increases the MV precision to 1/16 luma sample, to improve the prediction efficiency of slow motion video. This higher motion accuracy is particularly helpful for video contents with locally varying and non-translational motion such as in case of affine mode. For fractional position samples generation of higher MV accuracy, HEVC's 8-tap luma interpolation filters and 4-tap chroma interpolation filters are extended to 16 phases for luma and 32 phases for chroma. This extended filter set is applied in the motion compensation (MC) process of inter coded CUs except the CUs in affine mode. For affine mode, a set of 6-tap luma interpolation filter with 16 phases is used for lower computational complexity as well as memory bandwidth saving.

In VVC, the highest precision of explicitly signalled motion vectors for non-affine CU is quarter-luma-sample. In some inter prediction modes such as the affine mode, motion vectors can be signalled at 1/16-luma-sample precision. In all inter coded CU with implicitly inferred MVs, the MVs are derived at 1/16-luma-sample precision and motion compensated prediction is performed at 1/16-sample-precision. In terms of internal motion field storage, all motion vectors are stored at 1/16-luma-sample precision.

For temporal motion field storage used by TMVP and SbTMVP, motion field compression is performed at 8×8 size granularity in contrast to the 16×16 size granularity in HEVC.

### 2.1.3 Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

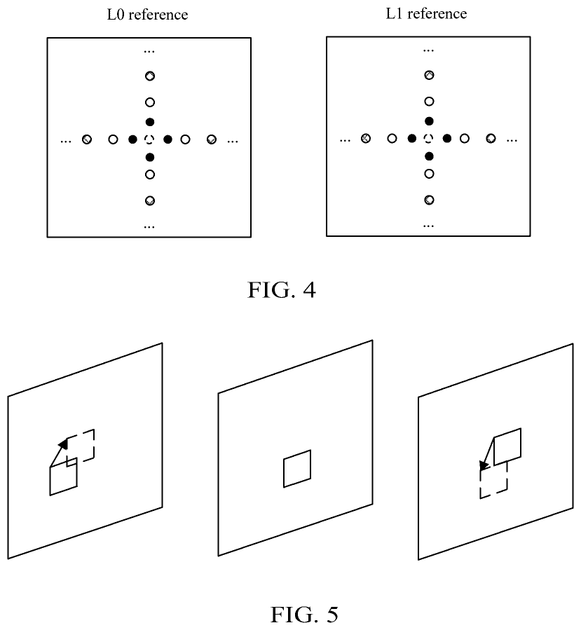

FIG. 4 illustrates an example MMVD search point. Distance index specifies motion magnitude information and indicate the pre-defined offset from the starting point. As shown in FIG. 4, an offset is added to either horizontal component or vertical component of starting MV. The relation of distance index and pre-defined offset is specified in Table 3-6

TABLE 3-6
The relation of distance index and pre-defined offset

| Distance index (IDX) | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3-7. It's noted that the meaning of MVD sign could be variant according to the information of starting MVs. When the starting MVs is an un-prediction MV or bi-prediction MVs with both lists point to the same side of the current picture (i.e., POCs of two references are both larger than the POC of the current picture, or are both smaller than the POC of the current picture), the sign in Table 3-7 specifies the sign of MV offset added to the starting MV. When the starting MVs is bi-prediction MVs with the two MVs point to the different sides of the current picture (i.e., the POC of one reference is larger than the POC of the current picture, and the POC of the other reference is smaller than the POC of the current picture), and the difference of POC in list 0 is greater than the one in list 1, the sign in Table 3-7 specifies the sign of MV offset added to the list0 MV component of starting MV and the sign for the list1 MV has opposite value. Otherwise, if the difference of POC in list 1 is greater than list 0, the sign in Table 3-7 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 4. If the POC difference of L1 is greater than L0, the MVD for list 0 is scaled in the same way. If the starting MV is uni-predicted, the MVD is added to the available MV.

TABLE 3-7
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.1.4 Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived. FIG. 5 illustrates an example of symmetrical MVD mode.

The decoding process of the symmetric MVD mode is as follows:
1. At slice level, variables BiDirPredFlag, RefIdxSymL0 and RefIdxSymL1 are derived as follows:
   If mvd_11_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2. At CU level, a symmetrical mode flag indicating whether symmetrical mode is used or not is explicitly signaled if the CU is bi-prediction coded and BiDirPredFlag is equal to 1.

When the symmetrical mode flag is true, only mvp_10_flag, mvp_11_flag and MVD0 are explicitly signaled. The reference indices for list-0 and list-1 are set equal to the pair of reference pictures, respectively. MVD1 is set equal to (−MVD0). The final motion vectors are shown in formula below.

$$\{ ( m v {x}_{0} , mv {y}_{0} ) = ( {mvpx}_{0} + m v d {x}_{0} , mvp {y}_{0} + m v d {y}_{0} ) ( {mvx}_{1} , {mvy}_{1} ) = \text{} ( mvp {x}_{1} - m v d {x}_{0} , mvp {y}_{1} - m v d {y}_{0} ) \qquad ( 3 - 14 )$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.1.5 Affine Motion Compensated Prediction

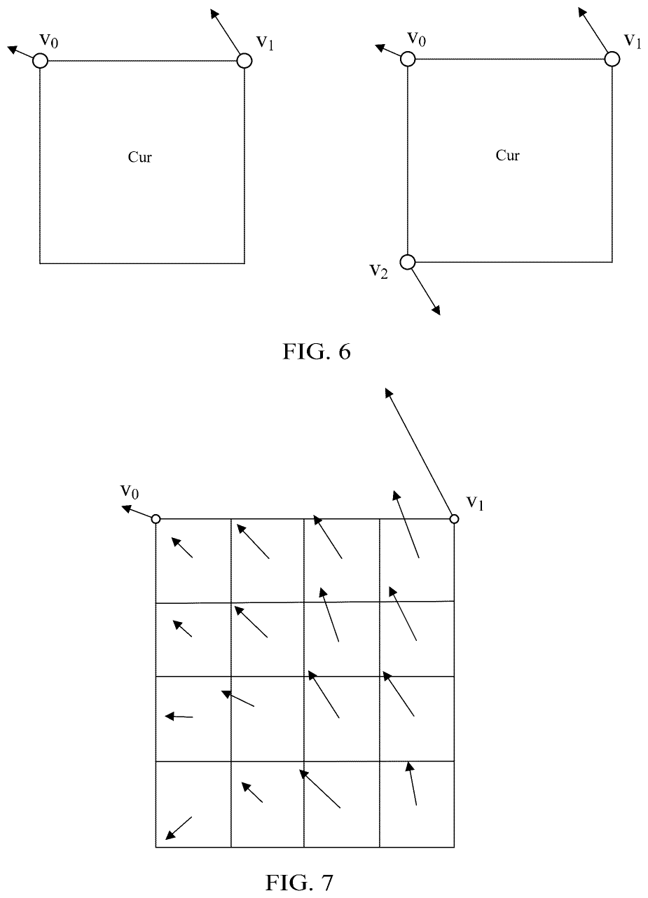

FIG. 6 illustrates an example control point based affine motion model, including a 4-parameter affine model and a 6-parameter affine model. In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. As shown FIG. 6, the affine motion field of the block is described by motion information of two control point (4-parameter) or three control point motion vectors (6-parameter).

For 4-parameter affine motion model, motion vector at sample location (x, y) in a block is derived as:

$$( 3 - 15 )$$

$$\{ {mv}_{x} = \frac{{mv}_{1 x} - {mv}_{0 x}}{W} x + \frac{{mv}_{0 y} - {mv}_{1 y}}{W} y + m {v}_{0 x} {mv}_{y} = \frac{{mv}_{1 y} - {mv}_{0 y}}{W} x + \frac{{mv}_{1 x} - {mv}_{0 x}}{W} y + m {v}_{0 y}$$

For 6-parameter affine motion model, motion vector at sample location (x, y) in a block is derived as:

$$( 3 - 16 )$$

$$\{ m {v}_{x} = \frac{{mv}_{1 x} - {mv}_{0 x}}{W} x + \frac{{mv}_{2 x} - {mv}_{0 x}}{H} y + {mv}_{0 x} {mv}_{y} = \frac{{mv}_{1 y} - {mv}_{0 y}}{W} x + \frac{{mv}_{2 y} - {mv}_{0 y}}{H} y + {mv}_{0 y}$$

Where (mv0x, mv0y) is motion vector of the top-left corner control point, (mv1x, mv1y) is motion vector of the top-right corner control point, and (mv2x, mv2y) is motion vector of the bottom-left corner control point.

FIG. 7 illustrates an example affine MVF per subblock. In order to simplify the motion compensation prediction, block based affine transform prediction is applied. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.1.5.1 Affine Merge Prediction

AF_MERGE mode can be applied for CUs with both width and height larger than or equal to 8. In this mode the Control point motion vectors (CPMVs) of the current CU is generated based on the motion information of the spatial neighboring CUs. There can be up to five CPMVP candidates and an index is signalled to indicate the one to be used for the current CU. The following three types of CPMV candidate are used to form the affine merge candidate list:
Inherited affine merge candidates that extrapolated from the CPMVs of the neighbour CUs
Constructed affine merge candidates CPMVPs that are derived using the translational MVs of the neighbour CUs
Zero MVs

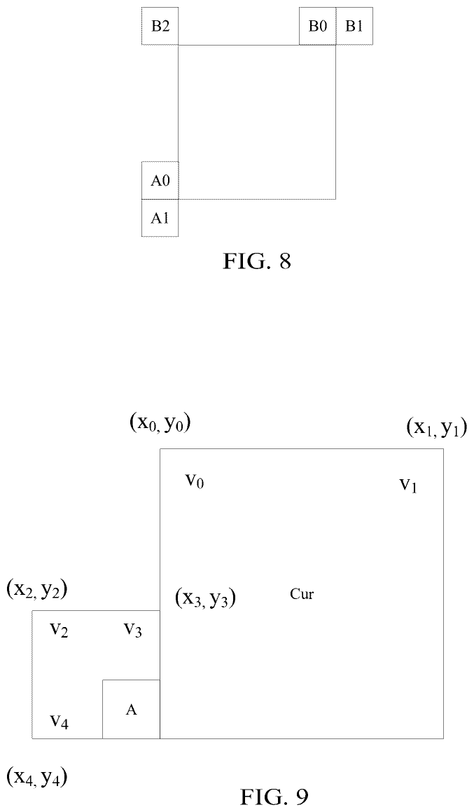

In VVC, there are maximum two inherited affine candidates, which are derived from affine motion model of the neighboring blocks, one from left neighboring CUs and one from above neighboring CUs. The candidate blocks are shown in FIG. 8. FIG. 8 illustrates example locations of inherited affine motion predictors. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. FIG. 9 illustrates an example of control point motion vector inheritance. As shown in FIG. 9, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

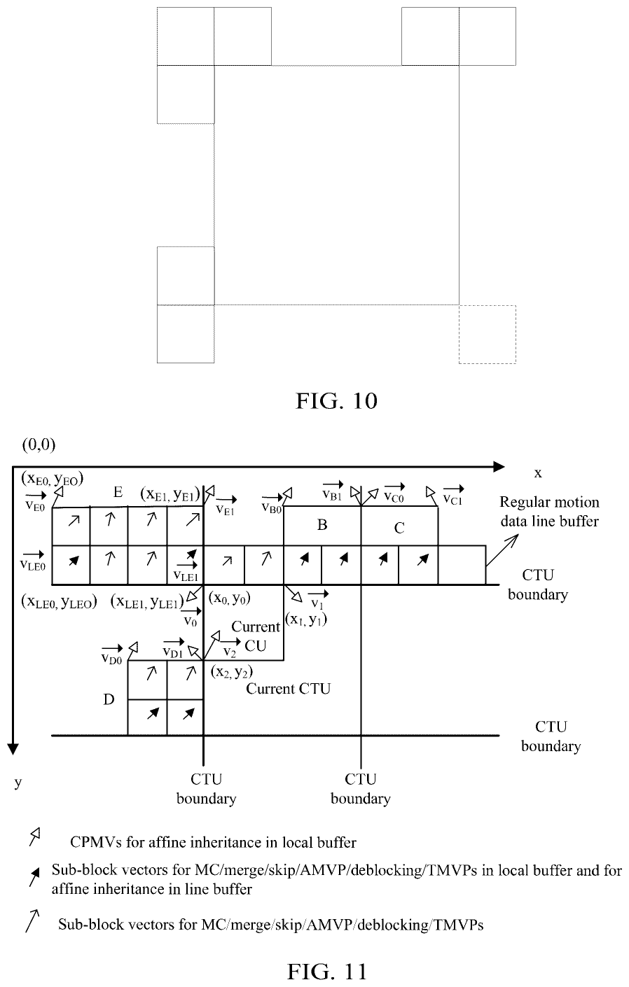

Constructed affine candidate means the candidate is constructed by combining the neighbor translational motion information of each control point. The motion information for the control points is derived from the specified spatial neighbors and temporal neighbor shown in FIG. 10. FIG. 10 illustrates example locations of candidate positions for constructed affine merge mode. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order:
{CPMV1, CPMV2, CPMV3}, {CPMV1, CPMV2, CPMV4}, {CPMV1, CPMV3, CPMV4},
{CPMV2, CPMV3, CPMV4}, {CPMV1, CPMV2}, {CPMV1, CPMV3}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.1.5.2 Affine AMVP Prediction

Affine advanced motion vector prediction (AMVP) mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighboring CUs
Zero MVs

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mvo and mv1 are both availlalbe, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after valid inherited affine AMVP candidates and constructed AMVP candidate are inserted, mv₀, mv₁ and mv₂ will be added, in order, as the translational MVs to predict all control point MVs of the current CU, when available. Finally, zero MVs are used to fill the affine AMVP list if it is still not full.

### 2.1.5.3 Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and deblocking.

FIG. 11 illustrates an example of MV usage for a combined method. To avoid the picture line buffer for the additional CPMVs, affine motion data inheritance from the CUs from above coding tree unit (CTU) is treated differently to the inheritance from the normal neighboring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 11, along the top CTU boundary, the bottom-left and bottom right subblock motion vectors of a CU are used for affine inheritance of the CUS in bottom CTUs.

### 2.1.5.4 Prediction Refinement with Optical Flow for Affine Mode

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:
Step 1) The subblock-based affine motion compensation is performed to generate subblock prediction I (i,j).
Step2) The spatial gradients gₓ(i, j) and g_{y}(i,j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) ≫ shift 1 ) - ( I ( i - 1 , j ) ≫ shift 1 ) \qquad ( 3 - 17 )$$

$${g}_{y} ( i , j ) = ( I ( i , j + 1 ) ≫ shift 1 ) - ( I ( i , j - 1 ) ≫ shift 1 ) \qquad ( 3 - 18 )$$

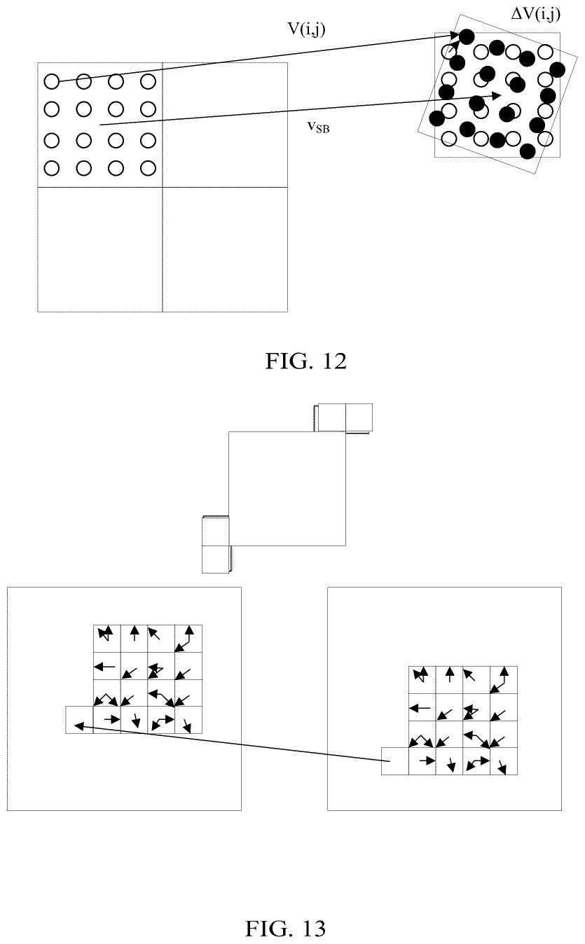

shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.
Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 3 - 19 )$$

where the Δv(i, j) is the difference between sample MV computed for sample location (i, j), denoted by v(i, j), and the subblock MV of the subblock to which sample (i, j) belongs, as shown in FIG. 12. FIG. 12 illustrates an example of a subblock MV V_{SB} and pixel. The Δv(i, j) is quantized in the unit of 1/32 luma sample precision.

Since the affine model parameters and the sample location relative to the subblock center are not changed from subblock to subblock, Δv(i, j) can be calculated for the first subblock, and reused for other subblocks in the same CU. Let dx(i,j) and dy(i, j) be the horizontal and vertical offset from the sample location (i, j) to the center of the subblock (x_{SB}, y_{SB}), Δv(x, y) can be derived by the following equation,

$$\{ dx ( i , j ) = i - {x}_{S B} dy ( i , j ) = j - {y}_{S B} \qquad ( 3 - 20 )$$

$$\{ Δ {v}_{x} ( i , j ) = C * dx ( i , j ) + D * dy ( i , j ) Δ {v}_{y} ( i , j ) = E * dx ( i , j ) + F * dy ( i , j ) \qquad ( 3 - 21 )$$

In order to keep accuracy, the center of the subblock (x_{SB}, y_{SB}) is calculated ((WSB−1)/2, (HSB−1)/2), where WSB and HSB are the subblock width and height, respectively.

For 4-parameter affine model,

$$\{ C = F = \frac{{ν}_{1 x} - {ν}_{0 x}}{w} E = - D = \frac{{ν}_{1 y} - {ν}_{0 y}}{w} \qquad ( 3 - 22 )$$

For 6-parameter affine model,

$$\{ C = \frac{{ν}_{1 x} - {ν}_{0 x}}{w} D = \frac{{ν}_{2 x} - {ν}_{0 x}}{h} E = \frac{{ν}_{1 y} - {ν}_{0 y}}{w} F = \frac{{ν}_{2 y} - {ν}_{0 y}}{h} \qquad ( 3 - 23 )$$

where (v₀ₓ, v_{0y}), (v₁ₓ, v_{1,y}), (v₂ₓ, v_{2y}) are the top-left, top-right and bottom-left control point motion vectors, w and h are the width and height of the CU.

Step 4) Finally, the luma prediction refinement ΔI(i, j) is added to the subblock prediction I(i, j). The final prediction I′ is generated as the following equation.

$${I}^{′} ( i , j ) = I ( i , j ) + Δ I ( i , j )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.1.6 Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

FIG. 13 illustrates an example of the SbTMVP process in VVC. FIG. 13 includes a diagram illustrating Spatial neighboring blocks used by Alternate Temporal Vector Movement Prediction (ATVMP). FIG. 13 also includes a diagram illustrating deriving sub-CU motion field by applying a motion shift from spatial neighbor and scaling the motion information from the corresponding collocated sub-CUs.

SbTMVP predicts the motion vectors of the sub-CUs within the current CU in two steps. In the first step, the spatial neighbor A1 in (a) of FIG. 13 is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e., added to the current block's coordinates) to obtain sub-CU level motion information (motion vectors and reference indices) from the collocated picture as shown in (b) of FIG. 13. The example in (b) of FIG. 13 assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional rate distortion (RD) check is performed to decide whether to use the SbTMVP candidate.

### 2.1.7 Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Dependent on the mode (normal AMVP mode or affine AMVP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate half-luma-sample or other MVD precisions (integer or four-luma sample) is used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing CU-level RD check four times for each MVD resolution, in VVC test model (VTM) 14, the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode is used as starting search point in 1/16 luma-sample and quarter-luma-sample MV precision affine inter modes.

### 2.1.8 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{b i - p r e d} = ( ( 8 - w ) * {P}_{0} + w * {P}_{1} + 4 ) ≫ 3 \qquad ( 3 - 24 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (wÅ{3,4,5}) are used.
At the encoder, fast search algorithms are applied to find the weight index without significantly increasing the encoder complexity. These algorithms are summarized as follows. For further details readers are referred to the VTM software and document Joint Video Experts Team (JVET)-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding quantization parameter (QP), and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/Advanced Video Coding (AVC) and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e., equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 2.1.9 Bi-Directional Optical Flow (BDOF)

The bi-directional optical flow (BDOF) tool is included in VVC. BDOF, previously referred to as BIO, was included in the joint exploration model (JEM). Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e., POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \qquad ( 3 - 25 )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)} (i, j) are the sample value at coordinate (i, j) of the prediction signal in list k, k=0,1, and shift1 is calculated based on the luma bit depth, bitDepth, as shift1=max (6, bitDepth-6).

Then, the auto-and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , \qquad ( 3 - 26 )$$

$${S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) ,$$

$${S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 3 - 27 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min (1, bitDepth−11) and min (4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{α}} ) ≫ ⌊ {S}_{1} ⌋ ) ) : 0 \qquad ( 3 - 28 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{α}} - \frac{( ( {v}_{x} {S}_{2 , m} ) ≪ {n}_{{S}_{2}} + {v}_{x} {S}_{2 , s} )}{2} ) ≫ ⌊ {S}_{5} ⌋ ) ) : 0$$

where S_{2,m}=S₂»n_{S2}, S_{2,s}=S₂&(2ⁿ^{_{s.2}}−1), th′_{B10}=2^{max(5,BD-7)}. [⋅] is the floor function, and n_{S}_{₂}=12.

Based on the motion refinement and the gradients, the following adjustment is calculated for each sample in the 4×4 subblock:

$$b ( x , y ) = rnd ( \text{} ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) \text{} / \text{} 2 ) \qquad ( 3 - 29 )$$

Finally, the BDOF samples of the CU are calculated by adjusting the bi-prediction samples as follows:

$$p r e {d}_{BDOF} ( x , y ) = ( {I}^{( 0 )} ( x , y ) + {I}^{( 1 )} ( x , y ) + b ( x , y ) + {o}_{offset} ) ≫ shift \qquad ( 3 - 30 )$$

These values are selected such that the multipliers in the BDOF process do not exceed 15-bit, and the maximum bit-width of the intermediate parameters in the BDOF process is kept within 32-bit.

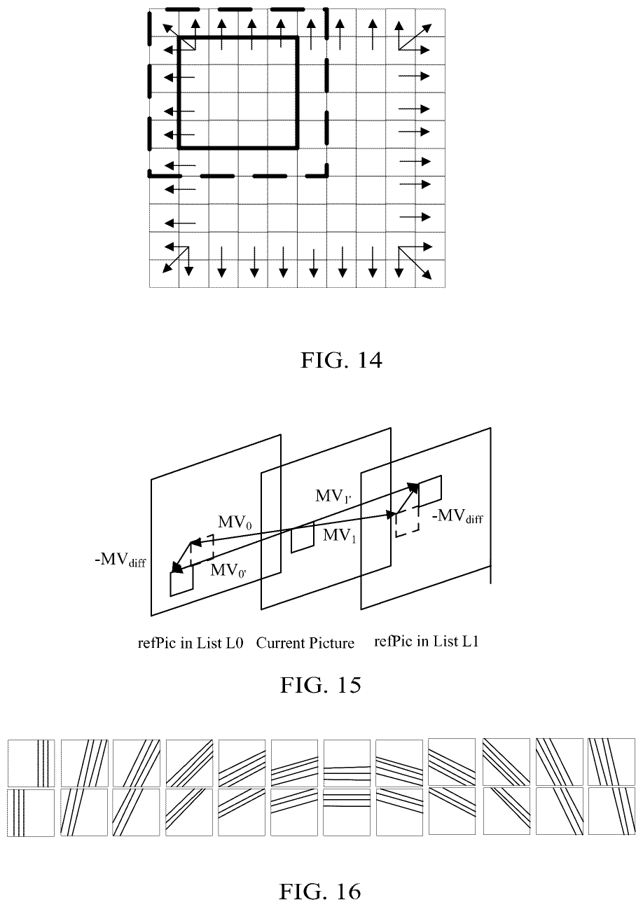

In order to derive the gradient values, some prediction samples I^{(k)} (i, j) in list k (k=0,1) outside of the current CU boundaries need to be generated. FIG. 14 illustrates an example extended CU region used in BDOF. As depicted in FIG. 14, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e., repeated) from their nearest neighbors.

When the width and/or height of a CU are larger than 16 luma samples, the CU will be split into subblocks with width and/or height equal to 16 luma samples, and the subblock boundaries are treated as the CU boundaries in the BDOF process. The maximum unit size for BDOF process is limited to 16×16. For each subblock, the BDOF process could be skipped. When the sum of absolute difference (SAD) between the initial L0 and L1 prediction samples is smaller than a threshold, the BDOF process is not applied to the subblock. The threshold is set equal to (8*W*(H»1), where W indicates the subblock width, and H indicates subblock height. To avoid the additional complexity of SAD calculation, the SAD between the initial L0 and L1 prediction samples calculated in DMVR process is re-used here.

If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.

### 2.1.10 Decoder Side Motion Vector Refinement (DMVR)

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 15 illustrates an example of decoder side motion vector refinement. As illustrated in FIG. 15, the SAD between the solid-line blocks in the refPic in List 0 and in the refPic in List 1 based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e., POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.1.10.1 Searching Scheme

In DMVR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 3 - 31 )$$

$$MV {1}^{′} = MV 1 - MV\_offset \qquad ( 3 - 32 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

A 25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 3 - 33 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 3 - 34 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 3 - 35 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.1.10.2 Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DMVR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.1.10.3 Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.1.11 Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×vh=2^{m}×2ⁿ with m, n∈{3 . . . 6} excluding 8×64 and 64×8.

When this mode is used, a CU is split into two parts by a geometrically located straight line (FIG. 16). FIG. 16 illustrates an example of GPM splits grouped by identical angles. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in 3.4.11.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in 3.4.11.2. This is the prediction signal for the whole CU, and transform and quantization process will be applied to the whole CU as in other prediction modes. Finally, the motion field of a CU predicted using the geometric partition modes is stored as in 3.4.11.3.

### 2.1.11.1 Uni-Prediction Candidate List Construction

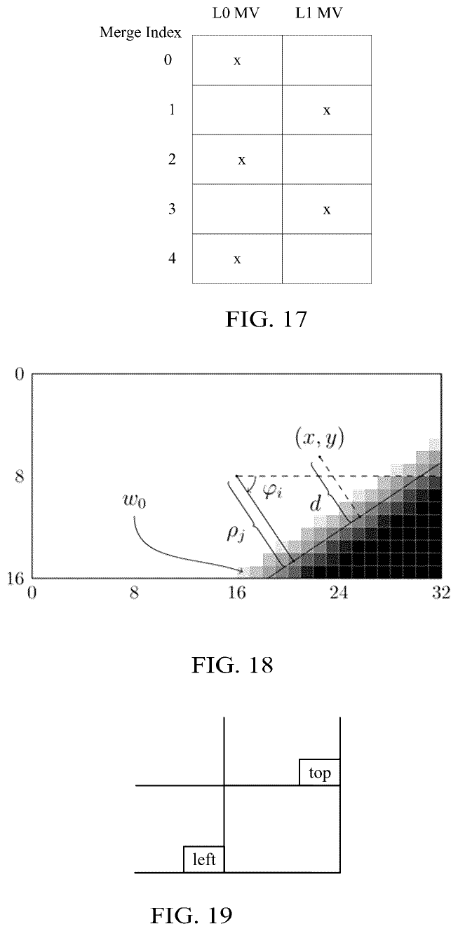

The uni-prediction candidate list is derived directly from the merge candidate list constructed according to the extended merge prediction process in 3.4.1. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 17. FIG. 17 illustrates an example of uni-prediction MV selection for a geometric partitioning mode. In case a corresponding LX motion vector of the n-the extended merge candidate does not exist, the L(1−X) motion vector of the same candidate is used instead as the uni-prediction motion vector for geometric partitioning mode.

### 2.1.11.2 Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos cos ( {φ}_{i} ) + ( 2 y + 1 - h ) sin sin ( {φ}_{i} ) - {ρ}_{j} \qquad ( 3 - 36 )$$

$${ρ}_{j} = {ρ}_{x , j} cos cos ( {φ}_{i} ) + {ρ}_{y , j} sin sin ( {φ}_{i} ) \qquad ( 3 - 37 )$$

$${ρ}_{x , j} = \{ 0 i \% 16 = 8 or ( i \% 16 \neq 0 and h \geq w ) \pm ( j \times w ) ≫ 2 otherwise \qquad ( 3 - 38 )$$

$${ρ}_{y , j} = \{ \pm ( j \times h ) ≫ 2 i \% 16 = 8 or ( i \% 16 \neq 0 and h \geq w ) 0 otherwise \qquad ( 3 - 39 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 3 - 40 )$$

$${w}_{0} ( x , y ) = \frac{Clip 3 ( 0 , 8 , ( wIdxL ( x , y ) + 4 ) ≫ 3 )}{8} \qquad ( 3 - 41 )$$

$${w}_{1} ( x , y ) = 1 - {w}_{0} ( x , y ) \qquad ( 3 - 42 )$$

The partIdx depends on the angle index i. One example of weigh wo is illustrated in FIG. 18. FIG. 18 illustrates an example of exemplified generation of a bending weight using geometric partitioning mode.

### 2.1.11.3 Motion Field Storage for Geometric Partitioning Mode

Mv1 from the first part of the geometric partition, Mv2 from the second part of the geometric partition, and a combined Mv of Mv1 and Mv2 are stored in the motion filed of a geometric partitioning mode coded CU. The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 3 - 43 )$$

where motionIdx is equal to d 4x+2, 4y+2), which is recalculated from equation (3-36). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.1.12 Combined Inter and Intra Prediction (CIIP)

FIG. 19 illustrates an example of top and left neighboring blocks used in CIIP weight derivation. In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pintra is derived following the regular intra prediction process with the planar mode. Then, the intra and inter prediction signals are combined using weighted averaging, where the weight value is calculated depending on the coding modes of the top and left neighbouring blocks (depicted in FIG. 19) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{i n t e r} + wt * {P}_{i n t r a} + 2 ) >> 2 \qquad ( 3 ‐ 43 )$$

### 2.1.13 Reference Picture Resampling (RPR)

In HEVC, the spatial resolution of pictures cannot change unless a new sequence using a new SPS starts, with an intra random access point (IRAP) picture. VVC enables picture resolution change within a sequence at a position without encoding an IRAP picture, which is always intra-coded. This feature is sometimes referred to as reference picture resampling (RPR), as the feature needs resampling of a reference picture used for inter prediction when that reference picture has a different resolution than the current picture being decoded. In order to avoid additional processing steps, the RPR process in VVC is designed to be embedded in the motion compensation process and performed at the block level. In the motion compensation stage, the scaling ratio is used together with motion information to locate the reference samples in the reference picture to be used in the interpolation process.

In VVC, the scaling ratio is restricted to be larger than or equal to ½ (2 times downsampling from the reference picture to the current picture), and less than or equal to 8 (8 times upsampling). Three sets of resampling filters with different frequency cutoffs are specified to handle various scaling ratios between a reference picture and the current picture. The three sets of resampling filters are applied respectively for the scaling ratio ranging from 1/2 to 1/1.75,from 1/1.75 to 1/1.25, and from 1/1.25 to 8. Each set of resampling filters has 16 phases for luma and 32 phases for chroma which is same to the case of motion compensation interpolation filters. It is worthy noted that the filter set of normal MC interpolation is used in the case of scaling ratio ranging from 1/1.25 to 8. Actually the normal MC interpolation process is a special case of the resampling process with scaling ratio ranging from 1/1.25 to 8. In addition to conventional translational block motion, the affine mode has three sets of 6-tap interpolation filters that are used for the luma component to cover the different scaling ratios in RPR. The horizontal and vertical scaling ratios are derived based on picture width and height, and the left, right, top and bottom scaling offsets specified for the reference picture and the current picture.

For support of this feature, the picture resolution and the corresponding conformance window are signalled in the picture parameter set (PPS) instead of in the SPS, while in the SPS the maximum picture resolution is signalled.

### 2.1.14 Miscellaneous Inter Prediction Aspects

To reduce memory bandwidth, the inter-coded 4×4 size CU is not allowed in VVC. For inter-coded 4×8/8×4 CU, only uni-directional mode is allowed. When the motion information from merge mode is bi-directional, it is converted to uni-directional by keeping only the list 0 motion information.

### 3 Inter Prediction Tools Under Investigation in Enhanced Compression Model (ECM)

### 3.1 Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. Since α and β0 can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 3.2 Non-Adjacent Spatial Candidate

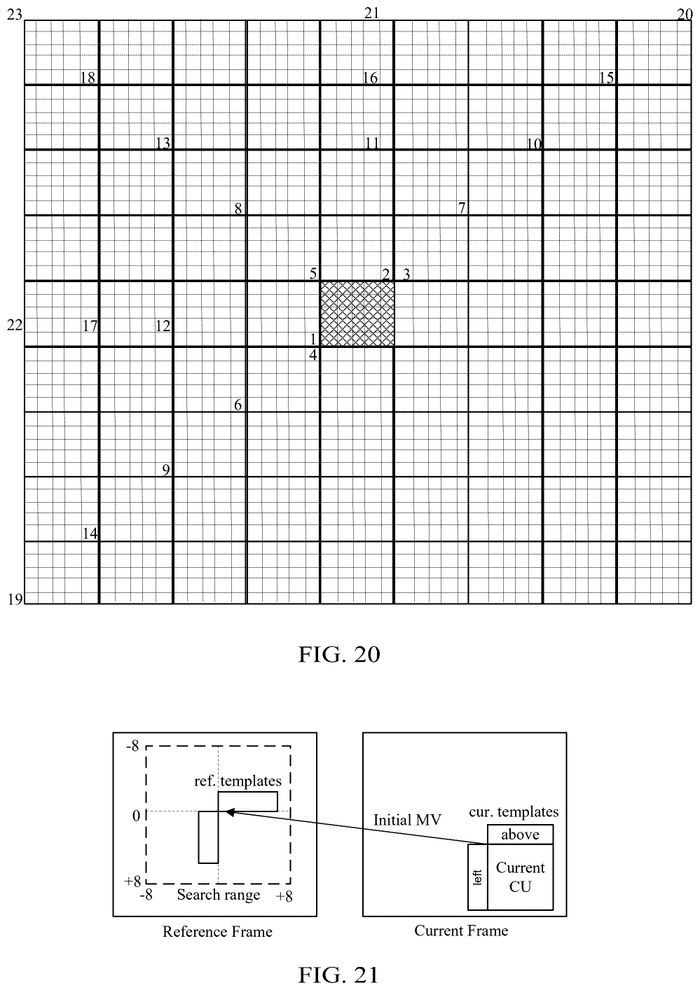

The non-adjacent spatial merge candidates as in Joint Video Experts Team (JVET)-L0399 are inserted after the TMVP in the regular merge candidate list. The pattern of spatial merge candidates is shown in FIG. 20. FIG. 20 illustrates an example of spatial neighboring blocks used to derive the spatial merge candidates. The distances between non-adjacent spatial candidates and current coding block are based on the width and height of current coding block. The line buffer restriction is not applied.

### 3.3 Template Matching (TM)

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. FIG. 21 illustrates an example of template matching performed on a search area around an initial MV. As illustrated in FIG. 21, a better MV is searched around the initial motion of the current CU within a [−8, +8]-pel search range. The template matching method in JVET-J0021 is used with the following modifications: search step size is determined based on AMVR mode and TM can be cascaded with bilateral matching process in merge modes.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process.

TABLE 1
Search patterns of AMVR and merge mode with AMVR.

| | AMVR mode | | | | Merge mode | |
|---|---|---|---|---|---|---|
| Search pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, similar search method is applied to the merge candidate indicated by the merge index. As Table 1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 3.4 Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 3.4.1 First Pass-Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as:bilCost=mvDistanceCost+sadCost. When the block size cbW*cbH is greater than 64, mean-removed sum of absolute difference (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV$$

$$MV1\_pass1 = MV 1 - deltaMV$$

### 3.4.2 Second Pass-Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

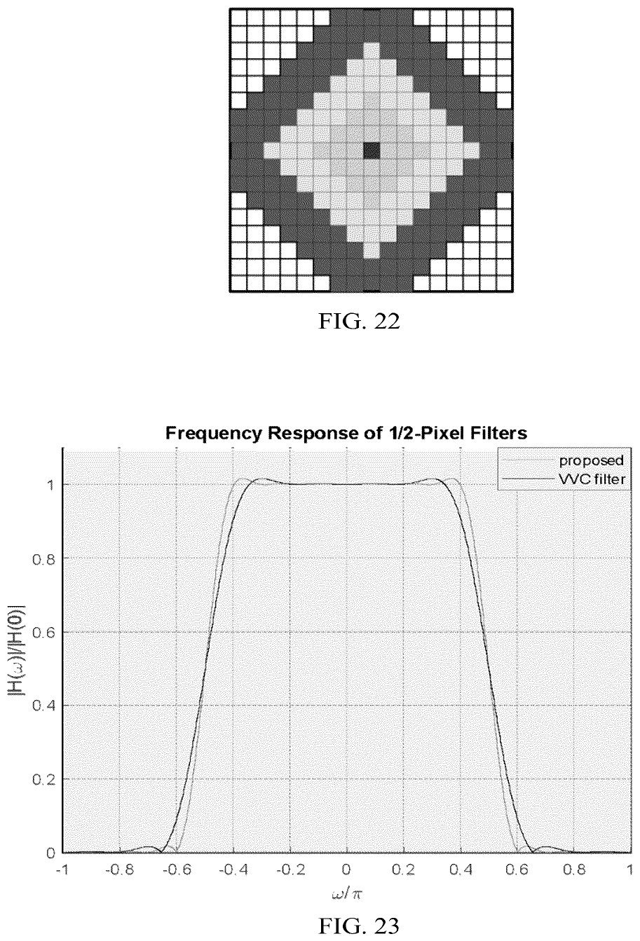

FIG. 22 illustrates an example of diamond regions in a search area. The bilateral matching cost is calculated by applying a cost factor to the sum of absolute transformed differences (SATD) cost between two reference subblocks, as: bilCost=satdCost*costFactor. The search area (2*sHor+1)*(2*sVer+1) is divided up to 5 diamond shape search regions shown on FIG. 22. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

The existing VVC DMVR fractional sample refinement is further applied to derive the final deltaMV (sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

### 3.4.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

### 3.5 OBMC

When overlapped block motion compensation (OBMC) is applied, top and left boundary pixels of a CU are refined using neighboring block's motion information with a weighted prediction as described in JVET-L0101.

Conditions of not applying OBMC are as follows:
When OBMC is disabled at SPS level
When current block has intra mode or intra block copy (IBC) mode
When current block applies LIC
When current luma block area is smaller or equal to 32

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

### 3.6 Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 3.7 Interpolation

The 8-tap interpolation filter used in VVC is replaced with a 12-tap filter. The interpolation filter is derived from the sinc function of which the frequency response is cut off at Nyquist frequency, and cropped by a cosine window function. Table 2 gives the filter coefficients of all 16 phases. FIG. 23 illustrates an example of frequency responses of an interpolation filter and a VVC interpolation filter at half-pel phase. FIG. 23 compares the frequency responses of the interpolation filters with the VVC interpolation filter, all at half-pel phase.

TABLE 2
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

### 3.8 Multi-Hypothesis Prediction (MHP)

In the multi-hypothesis inter prediction mode (JVET-M0425), one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows:

$${p}_{3} = ( 1 - α ) {p}_{b i} + α {h}_{3}$$

The weighting factor α is specified by the new syntax element add_hyp_weight_idx, according to the following mapping:

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pn having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### 3.9 Adaptive Reordering of Merge Candidates with Template Matching (ARMC-TM)

The merge candidates are adaptively reordered with template matching (TM). The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

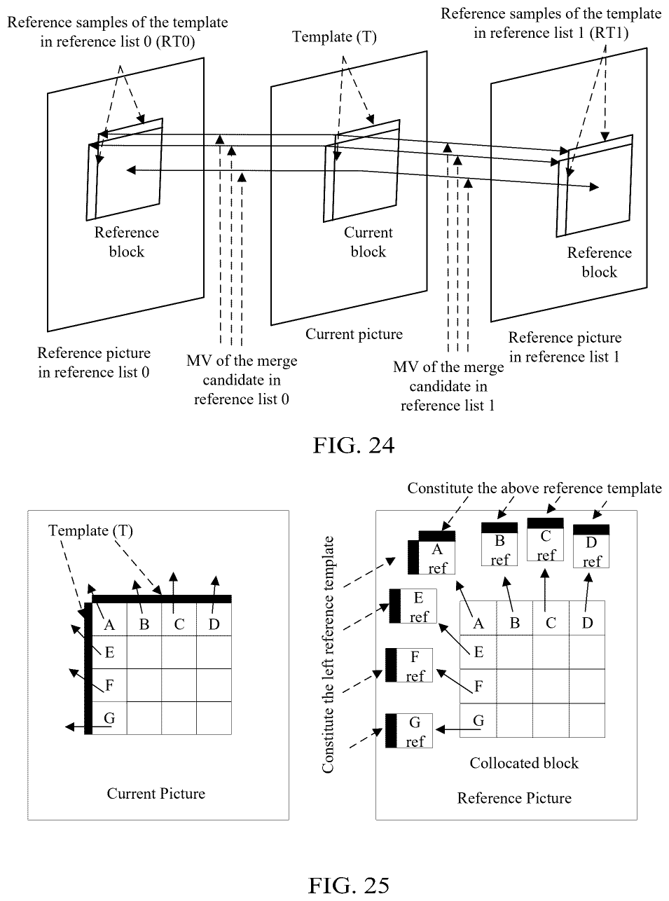

When a merge candidate utilizes bi-directional prediction, the reference samples of the template of the merge candidate are also generated by bi-prediction as shown in FIG. 24. FIG. 24 illustrates an example of template and reference samples of a template in reference pictures.

For subblock-based merge candidates with subblock size equal to Wsub×Hsub, the above template comprises several sub-templates with the size of Wsub×1, and the left template comprises several sub-templates with the size of 1×Hsub. As shown in FIG. 25, the motion information of the subblocks in the first row and the first column of current block is used to derive the reference samples of each sub-template. FIG. 25 illustrates an example of template and reference samples of the template for a block with sub-block motion using the motion information of the subblocks of the current block.

### 3.10 Geometric Partitioning Mode (GPM) with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

### 3.11 Geometric Partitioning Mode (GPM) with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 3. The motion is then refined by minimizing the difference between the current template and the template in the reference picture using the same search pattern of merge mode with half-pel interpolation filter disabled.

TABLE 3
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows:
1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.
4. The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

### 4. Technical Problems Solved by Disclosed Technical Solutions

Example designs for illumination compensation have the following problems. First, for each pixel in the current block, prediction is derived only based on the corresponding pixel from the motion compensated block. This ignores correlation pixel in the current block with neighboring pixels in the reference block, motivating for an improved LIC method that takes into account all the information from the neighboring pixels in the reference block.

Second, LIC parameters are derived based on the template. However, the distribution of the pixels in the template may differ from the distribution in the current block. This renders the DC prediction to be inaccurate. This motivates for an improved method for DC prediction.

Third, only one linear model is applied for LIC blocks which may not be optimal for all the scenarios. This motivates for multi-modal LIC.

### 5. A Listing of Solutions and Embodiments

To solve the above-described problems and some other problems not mentioned, methods as summarized below are disclosed. The embodiments should be considered as examples to explain the general concepts and should not be interpreted in a narrow way. Furthermore, these embodiments can be applied individually or combined in any manner.

The disclosed method is applicable in other scenarios where illumination compensation is employed such as inter-view prediction in multi-view coding.

The term ‘block’ may represent a coding block (CB), a CU, a PU, a prediction block (PB), etc.

### Example 1

An improved method for local illumination compensation (LIC) is disclosed. The following approaches are disclosed:

In one example, a new multiple-parameter LIC (MPLIC) model may be applied as follows:

$${Y}_{p r e d} = {α}_{0} {Y}_{0} + {α}_{1} {Y}_{1} + {α}_{2} {Y}_{2} … + {α}_{N - 1} {Y}_{N - 1} + β$$

where Y_{pred} is the predicted sample, Y₀, Y₁, Y₂, . . . Y_{N-1} reference samples derived based on at least one MV. α₀, α₁, α₂, . . . α_{N-1}, β are the model parameters.

### Example 2

In one example, Y₀ may be the reference pixel pointed by MV for the current pixel, Y₁, Y₂, . . . Y_{N-1} may be the neighboring pixels of Y₀.

### Example 3

In one example, Y₀ may be the reference sample for current sample X₀ derived based on at least one MV. Yᵢ (i=1, 2, . . . , N−1) may be derived with a predefined offset relative to Y₀. In one example, Y₀ may be the reference sample derived based on one MV if current block is uni-prediction. In one example, Y₀ may be the reference sample derived based on two MVs if current block is bi-prediction and only one model may be derived. In one example, Y₀ may be the reference sample derived based on one MV if current block is bi-prediction and two models may be derived for two directions.

### Example 4

In one example, Y₀ may be reference pixel obtained by a block vector, or template matching tools etc.

### Example 5

In one example, the MPLIC method may be used as an additional mode for LIC.

### Example 6

In one example, the MPLIC method may replace the LIC method disclosed in the background.

### Example 7

In one example, the choice of N and the neighbor positions Y₁, Y₂, . . . Yₙ may depend on factors such as: For example the choice may depend on coding information such as block size, quantization parameter (QP) value, etc. For example, different choices may be employed at the sequence/picture/slice/tile/CTU/CU level.

### Example 8

In one example, the MPLIC method may be used for the block with a specific coding mode such as AMVP or affine-AMVP or merge or sub-block merge.

### Example 9

In one example, the MPLIC method may be used under certain conditions like for certain sequences or frames or block sizes or QP values.

### Example 10

In one example, the above-mentioned methods may be applied for all color components or a subset of them. In one example, the choice of N and neighbors may be different for different color components. In one example, the above-mentioned methods may be applied only for luma component.

### Example 11

In one example, the MPLIC method may be applied only for uni-prediction. For example, the MPLIC method may be applied for both uni-prediction and bi-prediction.

### Example 12

In one example, the MPLIC method may be used only when the motion vector is not of fractional precision. For example, when motion vector is of integer precision, the MPLIC method may completely replace the existing LIC method. For example, the MPLIC method can be applied only when the MV precision is full-pel at least for AMVR mode. For example, when the MPLIC method is applied, a MV can only be signaled as full-pel at least. For example, when the MPLIC method is applied, a MV may be rounded to full-pel.

### Example 13

In one example, at least two different models may be employed, one model may process samples along the rows and the second model may subsequently process the samples along the columns or vice-versa. In one example, the number of models to be applied may depend on factors such as precision of the motion vector.

### Example 14

In one example, for merge mode, the usage of the MPLIC model is inherited from its usage in the neighbors.

### Example 15

In one example, for every merge candidate (say X) that uses the two parameter LIC model disclosed in the background, an additional merge candidate is inserted into the MV candidate list. In one example the new merge candidate may inherit all the information of the X candidate, and replace the LIC model with the new multiple-parameter LIC model. For example, only a subset of candidates in the MV candidate list is considered for constructing new merge candidates with new multiple-parameter LIC model. In one example, the block may be coded with a specific mode such as regular merge, MMVD, affine-merge, subblock merge, template matching merge, etc. The MV candidate list may be a regular merge list, an affine-merge list, template matching merge list, etc.

### Example 16

In one example, α₀, α₁, α₂, . . . αₙ, β are the model parameters derived by minimizing the following error function based on current block template and reference block template, no signaling overhead is required for them, except that an MPLIC flag is signaled for AMVP/affine AMVP mode to indicate the use of MPLIC.

In one example, the error function may be:

$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2} + {\sum }_{n = 0}^{N - 1} {{λ}_{n} ( {α}_{n} - {o}_{n} )}^{2}$$

wherein, X₀ is one sample in current template, Y₀ is the reference sample of X₀, Yᵢ (i=1, 2, . . . , N−1) has a predefined offset relative to Y₀, ∥T∥ is the number of template samples, λₙ is the regularization parameter, oₙ is predefined. For example, o₀=1, oᵢ (i=1, 2, . . . , N−1)=0.

Alternatively, the error function may be

$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2}$$

### Example 17

In an example, an improved method for DC prediction is disclosed. The following approaches are disclosed:

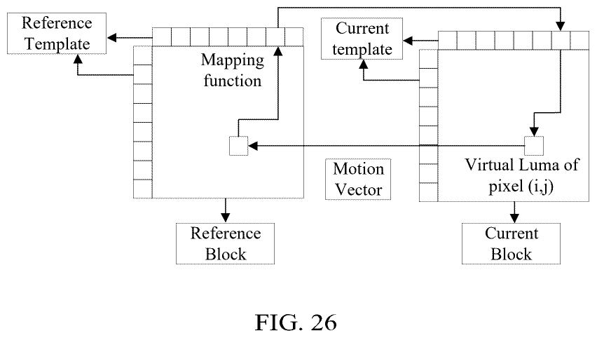

In one example, a mapping function is defined. For each sample in the current block, a corresponding virtual sample is derived using the mapping function, yielding a virtual block. In one example, the mapping function is formed between the reference block pixels and the reference template. This mapping function is used to map sample values in the current block to sample values in the current template which is neighboring to the current block. (see FIG. 26 for an example). FIG. 26 illustrates an example of virtual block generation for improved DC prediction. In one example, the DC of the virtual block is taken as the DC prediction of the current block.

### Example 18

In one example, the mapping function may be built based on the criterion such as minimum SAD, sum of squared error (SSE), etc., between the sample in the reference block and the samples in the reference template. In one example, if more than one reference template sample yield same minimum cost for a reference block sample, the closest sample in terms of spatial distance is selected.

### Example 19

In one example, the usage of this method may depend on coding/decoding information such as, for example, block size, QP etc. For example, other listed options and conditions in other embodiments.

### Example 20

In one example, a multi-model LIC is disclosed. The following approaches are disclosed. In one example, reference samples could be classified into different subsets and for each subset a different LIC model may be applied.

In one example, the LIC model for a subset could a two-parameter linear model or multi-parameter linear models disclosed previously or a combination thereof. In one example, the classification of references samples can be based on based on pre-defined threshold/s such as average of the sample values etc. In one example, the classification could be based on implicit methods such as clustering. In one example, the threshold/s may be explicitly signaled. In one example, there could be additional flexibility of selecting between implicit threshold/s and explicitly conveyed threshold/s. In one example, when used with geometric partition mode (GPM), the classification of the samples may be based on the partition of the template obtained by the partitioning in GPM. In one example, the usage of this method may depend on coding/decoding such as, for example, block size, QP etc. For example, other listed options and conditions in other embodiments.

### Example 21

In one example, for each of the above disclosed methods, a syntax element (e.g., a flag) may be signaled in the bitstream to specify whether the disclosed prediction mode is finally chosen for the current block coding. Furthermore, the syntax element may depend on whether the block is AMVP coded or merge coded.

### Example 22

Furthermore, the syntax element may depend on whether the block is uni-predicted or bi-predicted. In one example, if current block is bi-predicted, the syntax element may be inferred to be false.

### Example 23

Furthermore, the syntax element may depend on the type of the merge prediction used.

### Example 24

In an example, the syntax element is signalled only for a subset or all of Y, U, V planes.

### Example 25

Furthermore, the syntax element may be conditionally signalled.

### Example 26

Whether to/how to signal the syntax element may depend on the dimension of the current block. For example, the syntax element may be only signalled in case of the current block is greater than a pre-defined size. For example, the syntax element may be only signalled in case of the sum of width and height of current block is greater than a pre-defined threshold. In an example, greater than may be replaced by “lower than” or “no greater than” or “no lower than”.

### Example 27

Whether to/how to signal the syntax element may depend on the QP chosen to code the current block. For example, the syntax element may be only signalled in case of the QP for the current block is greater than a pre-defined threshold. In an example, greater than may be replaced by “lower than” or “no greater than” or “no lower than”.

### Example 28

In one example, the syntax element may be binarized as fixed length code, (truncated) unary code, exponential Golomb code, etc. In one example, the syntax element may be coded with at least one coding context in arithmetic coding. In one example, the syntax element may be coded with bypass coding.

### Example 29

Whether to and/or how to apply the disclosed methods above may be signalled at sequence level, group of pictures level, picture level, slice level, and/or tile group level, such as in sequence header, picture header, SPS, video parameter set (VPS), decoding parameter set (DPS), decoding capability information (DCI), PPS, adaptation parameter set (APS), slice header, and/or tile group header.

### Example 30

Whether to and/or how to apply the disclosed methods above may be signalled at PB, transform block (TB), CB, PU, TU, CU, virtual pipeline data unit (VPDU), CTU, CTU row, slice, tile, sub-picture, and/or other kinds of region contain more than one sample or pixel.

### Example 31

Whether to and/or how to apply the disclosed methods above may be dependent on coded information, such as block size, colour format, single/dual tree partitioning, colour component, slice/picture type.

### 6. References

[1] ITU-T and ISO/IEC, “High efficiency video coding”, Rec. ITU-T H.265|ISO/IEC 23008-2 (in force edition).
[2] B. Bross, J. Chen, S. Liu, and Y. -K. Wang “Versatile Video Coding (Draft 10),” document JVET-2001, 19th JVET meeting: by teleconference, 22 June-1 Jul. 2020.
[3] A. Browne, J. Chen, Y. Ye, S. Kim, Algorithm description for Versatile Video Coding and Test Model 14 (VTM 14),” JVET-W2002, September 2021.
[4] M. Coban, F. Le Léannec, J. Strom, “Algorithm description of Enhanced Compression Model 2 (ECM 2),” JVET-W2025, September 2021.
[5] VTM software: https://vcgit.hhi.fraunhofer.de/jvet/VVCSoftware_VTM.git
[6] ECM software: https://vcgit.hhi.fraunhofer.de/ecm/ECM.git

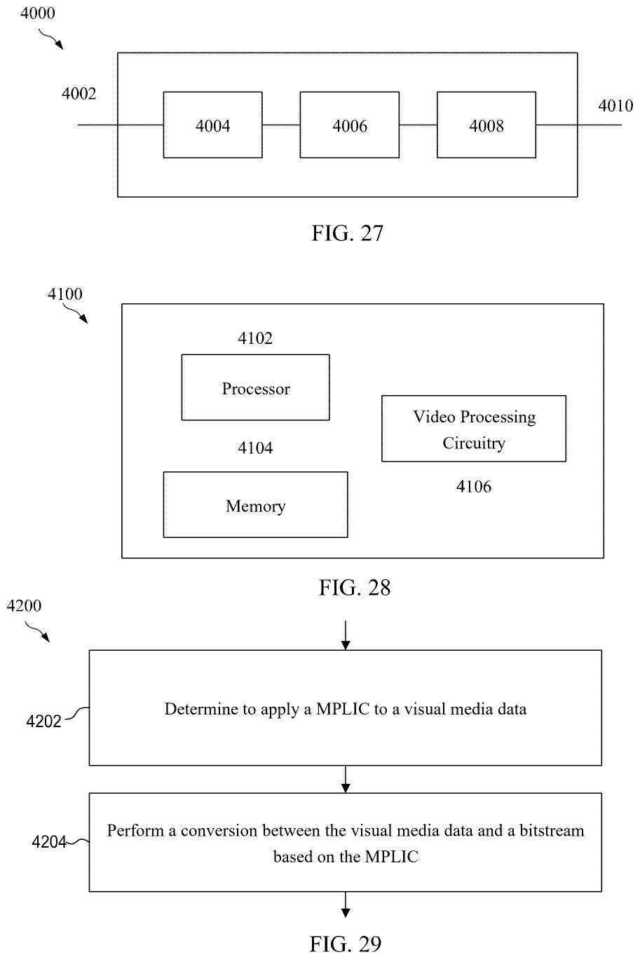

FIG. 27 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include Serial Advanced Technology Attachment (SATA), Peripheral Component Interconnect (PCI), Integrated Drive Electronics (IDE) interface, and the like. The techniques described in the present disclosure may be embodied in various electronic devices such as mobile phones, laptops, smartphones or other devices that are capable of performing digital data processing and/or video display.

FIG. 28 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

FIG. 29 is a flowchart for an example method 4200 of video processing. The method 4200 includes determining to apply a multiple-parameter local illumination compensation (MPLIC) to a visual media data at step 4202. A conversion is performed between the visual media data and a bitstream based on the MPLIC at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

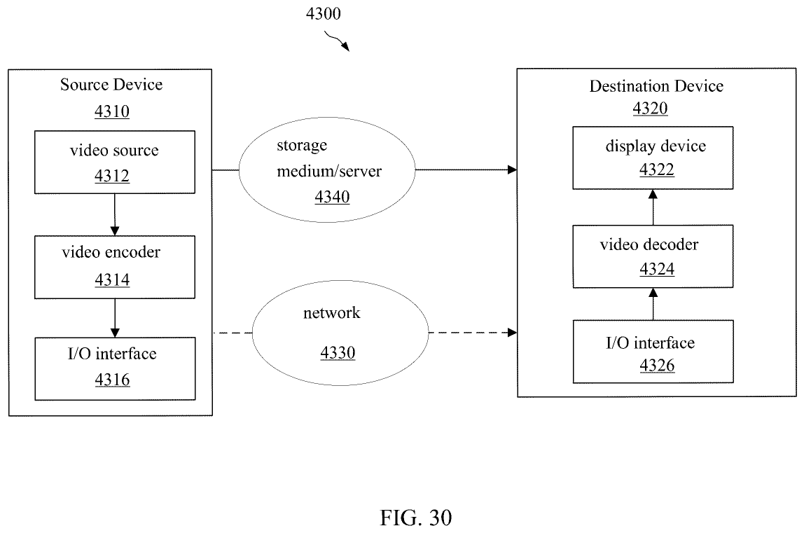

FIG. 30 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

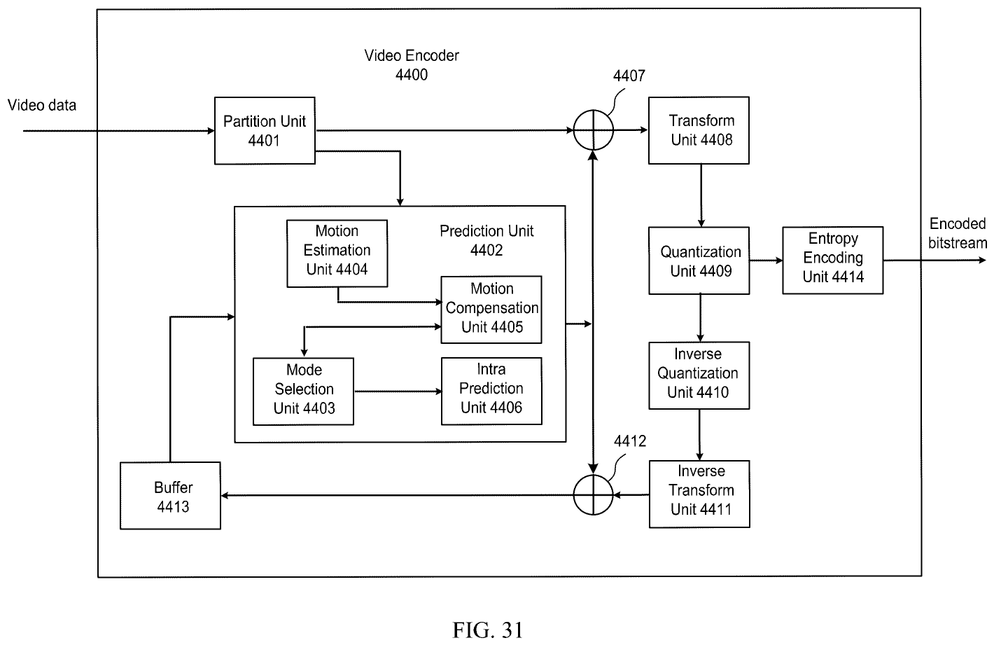

FIG. 31 is a block diagram illustrating an example of video encoder 4400, which may be video encoder 4314 in the system 4300 illustrated in FIG. 30. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

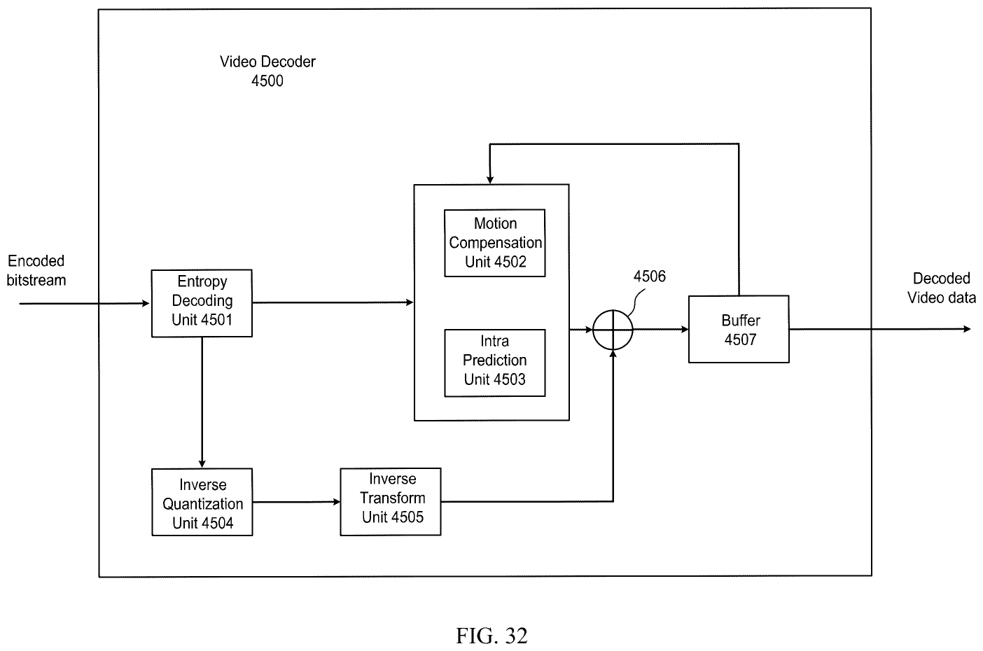

FIG. 32 is a block diagram illustrating an example of video decoder 4500 which may be video decoder 4324 in the system 4300 illustrated in FIG. 30. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

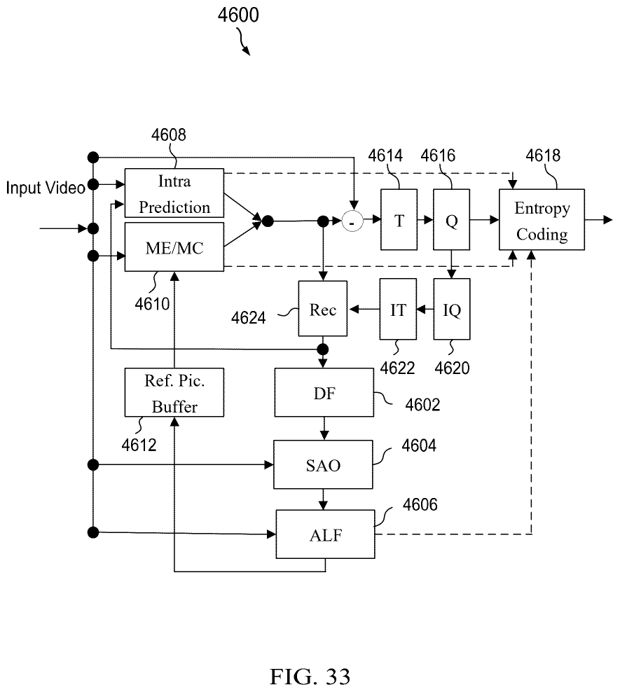

FIG. 33 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing video data comprising: determining to apply a multiple-parameter local illumination compensation (MPLIC) to a visual media data; and performing a conversion between the visual media data and a bitstream based on the MPLIC.
2. The method of solution 1, wherein the MPLIC is applied as follows:

$${Y}_{pred} = {α}_{0} {Y}_{0} + {α}_{1} {Y}_{1} + {α}_{2} {Y}_{2} … + {α}_{N - 1} {Y}_{N - 1} + β$$

where Y_{pred} is the predicted sample, Y₀, Y₁, Y₂, . . . Y_{N-1} reference samples derived based on at least one MV, and α₀, α₁, α₂, . . . αN−1, β are the model parameters.
3. The method of any of solutions 1-2, wherein Y₀ is the reference pixel pointed by a MV for a current pixel and Y₁, Y₂, . . . Y_{N-1} are neighboring pixels of Y₀.
4. The method of any of solutions 1-3, wherein Y₀ is a reference sample for a current sample X₀ derived based on at least one MV, and wherein Yᵢ (i=1, 2, . . . , N−1) is be derived with a predefined offset relative to Y₀.
5. The method of any of solutions 1-4, wherein Y₀ is a reference sample derived based on one MV when a current block uses uni-prediction, wherein Y₀ is a reference sample derived based on two MVs when a current block is bi-prediction and only one model is derived, or wherein Y₀ is a reference sample derived based on one MV when current block is bi-prediction and two models are derived for two directions.
6. The method of any of solutions 1-5, wherein Y₀ is a reference pixel obtained by a block vector or template matching tools.
7. The method of any of solutions 1-6, wherein a choice of N and neighbor positions Y₁, Y₂, . . . Yₙ depends on factors including coding information, and wherein different choices are employed at a sequence level, a picture level, a slice level, a tile level, a coding tree unit (CTU) level, a coding unit (CU) level, or combinations thereof.
8. The method of any of solutions 1-7, wherein MPLIC is used for a block employing advanced motion vector prediction (AMVP), affine-AMVP, or merge mode, or sub-block merge mode.
9. The method of any of solutions 1-8, wherein MPLIC is used for certain sequences, frames, block sizes, quantization parameter (QP) values, or combinations thereof.
10. The method of any of solutions 1-9, wherein MPLIC is applied to luma, blue difference chroma, red difference chroma, or combinations thereof.
11. The method of any of solutions 1-10, wherein MPLIC is applied only for unidirectional prediction or both unidirectional prediction and bidirectional prediction.
12. The method of any of solutions 1-11, wherein MPLIC is used only when a motion vector is not of fractional precision.
13. The method of any of solutions 1-12, wherein MPLIC include two models, and wherein a first model processes samples along rows and a second model processes samples along columns.
14. The method of any of solutions 1-13, wherein MPLIC usage is inherited from a neighbor block when a current block uses merge mode.
15. The method of any of solutions 1-14, wherein, α₀, α₁, α₂, . . . αₙ, and β are model parameters derived by minimizing an error function based on a current block template and reference block template.
16. The method of any of solutions 1-15, wherein the error function is:

$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2} + {\sum }_{n = 0}^{N - 1} {{λ}_{n} ( {α}_{n} - {o}_{n} )}^{2}$$

where X₀ is one sample in a current template, Y₀ is a reference sample of X₀, Yᵢ (i=1, 2, . . . , N−1) has a predefined offset relative to Y₀, ∥T∥ is a number of template samples, λₙ is a regularization parameter, and oₙ is a predefined value.
17. The method of any of solutions 1-16, wherein the error function is:

$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2}$$

where X₀ is one sample in a current template, Y₀ is a reference sample of X₀, Yᵢ (i=1, 2, . . . , N−1) has a predefined offset relative to Y₀, and ∥T∥ is a number of template samples.
18. The method of any of solutions 1-17, wherein a direct current (DC) prediction is employed, and wherein for each sample in a current block, a corresponding virtual sample is derived using a mapping function yielding a virtual block.
19. The method of any of solutions 1-18, wherein the mapping function is formed between reference block pixels and a reference template, wherein the mapping function is used to map sample values in a current block to sample values in a current template which is neighboring to the current block, and wherein a DC of a virtual block is taken as a DC prediction of the current block.
20. The method of any of solutions 1-19, wherein the mapping function is built based on a criterion between a sample in a reference block and samples in a reference template, and wherein when more than one reference template sample yields a same minimum cost for a reference block sample, the closest sample in terms of spatial distance is selected.
21. The method of any of solutions 1-20, wherein usage of the mapping function depends on coding information.
22. The method of any of solutions 1-21, wherein MPLIC employs reference samples classified into different subsets, and wherein a different local illumination compensation (LIC) model is applied for each subset.
23. The method of any of solutions 1-22, wherein the LIC model for a subset is a two-parameter linear model or a multi-parameter linear model, wherein classification of references samples is based on a pre-defined threshold, wherein classification is based on clustering, wherein classification is explicitly signaled, or wherein when used with geometric partition mode (GPM), classification of the samples is based on a partition of a template obtained by GPM partitioning.
24. The method of any of solutions 1-23, wherein the bitstream includes one or more syntax elements indicating whether a prediction mode is chosen for a current block.
25. The method of any of solutions 1-24, wherein the syntax element depends on: whether the current block is AMVP coded, whether the current block is merge coded, whether the current block is uni-predicted, whether the current block is bi-predicted, a type merge prediction, or combinations thereof.
26. The method of any of solutions 1-25, wherein the syntax element is conditionally signaled, signaled depending on a dimension of a current block, signaled depending on a quantization parameter (QP) used to code the current block, context coded, binarized, or combinations thereof.
27. An apparatus for processing video data comprising: a processor; and a non-transitory memory with instructions thereon, wherein the instructions upon execution by the processor, cause the processor to perform the method of any of solutions 1-26.
28. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-26.
29. A non-transitory computer-readable recording medium storing a bitstream of a video which is generated by a method performed by a video processing apparatus, wherein the method comprises: determining to apply a multiple-parameter local illumination compensation (MPLIC) to a visual media data; and generating the bitstream based on the determining.
30. A method for storing bitstream of a video comprising: determining to apply a multiple-parameter local illumination compensation (MPLIC) to a visual media data; generating the bitstream based on the determining; and storing the bitstream in a non-transitory computer-readable recording medium.
31. A method, apparatus, or system described in the present disclosure.

The following solutions show further examples of techniques discussed herein.
1. A method for processing video data comprising: determining to apply a multiple-parameter local illumination compensation (MPLIC) to a visual media data; and performing a conversion between the visual media data and a bitstream based on the MPLIC.
2. The method of solution 1, wherein the MPLIC is applied as follows: Y_{pred}=α₀Y₀+α₁Y₁+α₂Y₂ . . . +α_{N-1}Y_{N-1}+β where Y_{pred} is the predicted sample, Y₀, Y₁, Y₂, . . . Y_{N-1} are reference samples derived based on at least one motion vector (MV), and α0, α1, α2, . . . αN−1, β are model parameters.
3. The method of any of solutions 1-2, wherein Y₀ is the reference pixel pointed by a MV for a current pixel and Y₁, Y₂, . . . Y_{N-1} are neighboring pixels of Y₀.
4. The method of any of solutions 1-3, wherein Y₀ is a reference sample for a current sample X₀ derived based on at least one MV, and wherein Yᵢ (i=1, 2, . . . , N−1) is be derived with a predefined offset relative to Y₀.
5. The method of any of solutions 1-4, wherein Y₀ is a reference sample derived based on one MV when a current block uses uni-prediction, wherein Y₀ is a reference sample derived based on two MVs when a current block is bi-prediction and only one model is derived, or wherein Y₀ is a reference sample derived based on one MV when current block is bi-prediction and two models are derived for two directions.
6. The method of any of solutions 1-5, wherein Y₀ is a reference pixel obtained by a block vector or template matching tools.
7. The method of any of solutions 1-6, wherein MPLIC is used as an additional local illumination compensation (LIC) mode or instead of LIC.
8. The method of any of solutions 1-7, wherein a choice of N and neighbor positions Y₁, Y₂, . . . Yₙ depends on factors including coding information including block size or quantization parameter (QP) value, and wherein different choices are employed at a sequence level, a picture level, a slice level, a tile level, a coding tree unit (CTU) level, a coding unit (CU) level, or combinations thereof.
9. The method of any of solutions 1-8, wherein MPLIC is used for a block employing advanced motion vector prediction (AMVP), affine-AMVP, or merge mode, or sub-block merge mode.
10. The method of any of solutions 1-9, wherein MPLIC is used for certain sequences, frames, block sizes, quantization parameter (QP) values, or combinations thereof.
11. The method of any of solutions 1-10, wherein MPLIC is applied to all or a subset of color components, or wherein a choice of N and neighbors is different for different color components, or wherein MPLIC is applied only for a luma component.
12. The method of any of solutions 1-11, wherein MPLIC is applied only for unidirectional prediction or both unidirectional prediction and bidirectional prediction.
13. The method of any of solutions 1-12, wherein MPLIC is used only when a motion vector is not of fractional precision, or wherein when a motion vector is of integer precision, MPLIC completely replaces LIC, or wherein MPLIC is applied only when the MV precision is full-pel at least for adaptive motion vector resolution (AMVR) mode, or wherein when the MPLIC applied, a MV can only be signaled as at least full-pel, or when the MPLIC is applied, a MV is rounded to full-pel.
14. The method of any of solutions 1-13, wherein MPLIC include two models, and wherein a first model processes samples along rows and a second model processes samples along columns, or wherein a number of models to be applied depends precision of the motion vector.
15. The method of any of solutions 1-14, wherein MPLIC usage is inherited from a neighbor block when a current block uses merge mode.
16. The method of any of solutions 1-15, wherein for every merge candidate X that uses a two parameter LIC model, an additional merge candidate is inserted into a MV candidate list, or wherein an additional merge candidate inherits all the information of the merge candidate X and replaces a LIC model with a multiple-parameter LIC model, or wherein only a subset of candidates in a MV candidate list is considered for constructing additional merge candidates with a multiple-parameter LIC model, or wherein a block is coded with a regular merge, motion vector difference (MMVD), affine-merge, subblock merge, template matching merge, or combination thereof, or wherein the MV candidate list is a merge list, an affine-merge list, a template matching merge list, or combinations thereof.
17. The method of any of solutions 1-16, wherein, α₁, α₁, α₂, . . . αₙ, and β are model parameters derived by minimizing an error function based on a current block template and reference block template, and wherein no signaling overhead is employed except that an MPLIC flag is signaled for AMVP or affine AMVP mode to indicate a use of MPLIC.
18. The method of any of solutions 1-17, wherein the error function is: E=Σ_{∥T∥}(α₀Y₀+α₁Y₁+α₂Y₂ . . . +α_{N-1}Y_{N-1}+β−X₀)²+Σₙ₌₀^{N-1}λₙ(αₙ−oₙ)² where X₀ is one sample in a current template, Y₀ is a reference sample of X₀, Yᵢ (i=1, 2, . . . , N−1) has a predefined offset relative to Y₀, ∥T∥ is a number of template samples, λₙ is a regularization parameter, and oₙ is a predefined value or o₀=1, oᵢ (i=1, 2, . . . , N−1)=0.
19. The method of any of solutions 1-18, wherein the error function is: E=Σ_{∥T∥}(α₀Y₀+α₁Y₁+α₂Y₂ . . . +α_{N-1}Y_{N-1}+β−X₀)² where X₀ is one sample in a current template, Y₀ is a reference sample of X₀, Yᵢ (i=1, 2, . . . , N−1) has a predefined offset relative to Y₀, and ∥T∥ is a number of template samples.
20. The method of any of solutions 1-19, wherein a direct current (DC) prediction is employed, and wherein for each sample in a current block, a corresponding virtual sample is derived using a mapping function yielding a virtual block.
21. The method of any of solutions 1-20, wherein the mapping function is formed between reference block pixels and a reference template, wherein the mapping function is used to map sample values in a current block to sample values in a current template which is neighboring to the current block, or wherein a DC of a virtual block is taken as a DC prediction of the current block.
22. The method of any of solutions 1-21, wherein the mapping function is built based on a criterion between a sample in a reference block and samples in a reference template, or wherein when more than one reference template sample yields a same minimum cost for a reference block sample, the closest sample in terms of spatial distance is selected.
23. The method of any of solutions 1-22, wherein usage of the mapping function depends on coding information including block size or quantization parameter (QP) size.
24. The method of any of solutions 1-23, wherein MPLIC employs reference samples classified into different subsets, and wherein a different local illumination compensation (LIC) model is applied for each subset.
25. The method of any of solutions 1-24, wherein the LIC model for a subset is a two-parameter linear model or a multi-parameter linear model, wherein classification of references samples is based on a pre-defined threshold, wherein classification is based on clustering, wherein thresholds are explicitly signaled, wherein additional flexibility of selecting between implicit thresholds and explicitly conveyed thresholds is employed, wherein when used with geometric partition mode (GPM), classification of the samples is based on a partition of a template obtained by GPM partitioning, or wherein usage of MPLIC depends of coding information including block size, QP size.
26. The method of any of solutions 1-25, wherein the bitstream includes one or more syntax elements indicating whether a prediction mode is chosen for a current block.
27. The method of any of solutions 1-26, wherein the syntax element depends on: whether the current block is AMVP coded, whether the current block is merge coded, whether the current block is uni-predicted, whether the current block is bi-predicted, a type merge prediction, or combinations thereof, or wherein when a current block is bi-predicted, the syntax element is inferred to be false.
28. The method of any of solutions 1-27, wherein the syntax element is conditionally signaled, signaled for only a subset of Y, U, and V planes, signaled depending on a dimension of a current block, signaled depending on a quantization parameter (QP) used to code the current block, context coded, binarized as fixed length code, a truncated unary code, an exponential Golomb code, coded with at least one context in arithmetic coding include bypass coding, or combinations thereof.
29. The method of any of solutions 1-28, wherein the syntax element is only signalled when the current block is greater than a pre-defined size, or wherein the syntax element is only signalled when the sum of width and height of a current block is greater than, lower than, no greater than, or no lower than a pre-defined threshold, or wherein the syntax element is only signalled when a QP for the current block is greater than, lower than, no greater than, or no lower than a pre-defined threshold, or combinations thereof.
30. The method of any of solutions 1-29, wherein usage of the method is signaled at sequence level, group of pictures level, picture level, slice level, or tile group level, including in a sequence header, picture header, sequence parameter set (SPS), video parameter set (VPS), decoding parameter set (DPS), decoding capability information (DCI), picture parameter set (PPS), Adaptation Parameter Set (APS), slice header, or tile group header, or wherein usage of the method is signaled at a prediction block (PB), transform block (TB), coding block (CB), prediction unit (PU), transform unit (TU), coding unit (CU), virtual pipeline data unit (VPDU), coding tree unit (CTU), CTU row, slice, tile, sub-picture, or other region containing more than one sample or pixel.
31. The method of any of solutions 1-30, wherein application of the method is dependent on coded information including block size, color format, single tree partitioning, dual tree partitioning, color component, slice type, or picture type.
32. The method of any of solutions 1-31, wherein the conversion includes encoding the visual media data into the bitstream.
33. The method of any of solutions 1-31, wherein the conversion includes decoding the visual media data from the bitstream.
34. An apparatus for processing video data comprising: a processor; and a non-transitory memory with instructions thereon, wherein the instructions upon execution by the processor, cause the processor to perform the method of any of solutions 1-33.
35. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-33.
36. A non-transitory computer-readable recording medium storing a bitstream of a video which is generated by a method performed by a video processing apparatus, wherein the method comprises: determining to apply a multiple-parameter local illumination compensation (MPLIC) to a visual media data; and generating the bitstream based on the determining.
37. A method for storing bitstream of a video comprising: determining to apply a multiple-parameter local illumination compensation (MPLIC) to a visual media data; generating the bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including +10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video data, comprising:
determining to apply a multiple-parameter local illumination compensation (MPLIC) model to a first block of a video; and
performing a conversion between the first block and a bitstream of the video based on the MPLIC model.

2. The method of claim 1, wherein the MPLIC model is applied as follows:
$${Y}_{pred} = {α}_{0} {Y}_{0} + {α}_{1} {Y}_{1} + {α}_{2} {Y}_{2} … + {α}_{N - 1} {Y}_{N - 1} + β$$
where Y_{pred} is a predicted sample, Y₀, Y₁, Y₂, . . . . Y_{N-1} are reference samples derived based on at least one motion vector (MV), α₀, α₁, α₂, . . . α_{N--}, β are model parameters of the MPLIC model, and N is a positive integer.

3. The method of claim 2, wherein Y₀ is a reference sample pointed by a motion vector (MV) for a current sample, and Y₁, Y₂, . . . . Y_{N-1} are neighboring samples of Y₀.

4. The method of claim 2, wherein Y₀ is a reference sample for a current sample derived based on at least one MV, and wherein Yᵢ is derived with a predefined offset relative to Y₀, where i=1, 2, . . . , N−1, and
wherein Y₀ is a reference sample derived based on one motion vector (MV) when the first block uses uni-prediction, wherein Y₀ is a reference sample derived based on two MVs when the first block uses bi-prediction and only one model is derived, or wherein Y₀ is a reference sample derived based on one MV when the first block uses bi-prediction and two models are derived for two directions.

5. The method of claim 2, wherein Y₀ is a reference sample obtained by a block vector or template matching tools.

6. The method of claim 2, wherein a choice of N and neighboring samples Y₁, Y₂, . . . . Y_{N-1} depends on factors including coding information including a block size and/or a quantization parameter (QP) value, and wherein different choices are employed at a sequence level, a picture level, a slice level, a tile level, a coding tree unit (CTU) level, a coding unit (CU) level, or combinations thereof.

7. The method of claim 2, wherein a method based on the MPLIC model is applied to all or a subset of color components, or wherein a choice of N and neighboring samples Y₁, Y₂, . . . . Y_{N-1} is different for different color components, or wherein a method based on the MPLIC model is applied only for a luma component, or
wherein a method based on the MPLIC model is applied only for uni-prediction or for both uni-prediction and bi-prediction, or
wherein a method based on the MPLIC model is used only when a motion vector is not of fractional precision, or wherein when a motion vector is of integer precision, a method based on the MPLIC model completely replaces a LIC method, or wherein a method based on the MPLIC model is applied only when a MV precision is full-pel at least for an adaptive motion vector resolution (AMVR) mode, or wherein when a method based on the MPLIC model is applied, a motion vector is only signaled as full-pel at least, or when a method based on the MPLIC model is applied, a motion vector is rounded to full-pel.

8. The method of claim 1, wherein a method based on the MPLIC model is used as an additional mode for local illumination compensation (LIC) or replace a LIC method, or
wherein a method based on the MPLIC model is used for a block employing an advanced motion vector prediction (AMVP) coding mode, an affine-AMVP coding mode, or a merge mode, or a sub-block merge mode, or
wherein a method based on the MPLIC model is used for certain sequences, frames, block sizes, quantization parameter (QP) values, or combinations thereof.

9. The method of claim 1, wherein at least two different models are employed, and wherein a first model of the at least two different models processes samples along rows and a second model of the at least two different models subsequently processes samples along columns, or the first model of the at least two different models processes samples along columns and the second model of the at least two different models subsequently processes samples along rows, or
wherein a number of models to be applied depends precision of a motion vector, or
wherein a usage of the MPLIC model is inherited from a usage of the MPLIC model in a neighbor block when the first block uses a merge mode, or
wherein for every merge candidate denoted as X that uses a two parameter LIC model, an additional merge candidate is inserted into a motion vector candidate list, or wherein a new merge candidate inherits all information of the merge candidate X and a LIC model is replaced with the MPLIC model, or wherein only a subset of candidates in a motion vector candidate list is considered for constructing new merge candidates with the MPLIC model, or
wherein the first block is coded with a regular merge mode, a motion vector difference (MMVD) mode, an affine-merge mode, a subblock merge mode, a template matching merge mode, or combination thereof, or wherein a motion vector candidate list is a regular merge list, an affine-merge list, a template matching merge list, or combinations thereof.

10. The method of claim 1, wherein α₀, α₁, α₂, . . . αₙ, and β are model parameters derived by minimizing an error function based on a first block template and a reference block template, and wherein no signaling overhead is required for α₀, α₁, α₂, . . . αₙ, and β, except that an MPLIC flag is signaled for an advanced motion vector prediction (AMVP) mode or an affine AMVP mode to indicate a use of MPLIC,
wherein the error function is:
$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2} + {\sum }_{n = 0}^{N - 1} {{λ}_{n} ( {α}_{n} - {o}_{n} )}^{2}$$
where X₀ is one sample in the first block template, Y₀ is a reference sample of X₀, Y₁ has a predefined offset relative to Y₀, where i=1, 2,. . . , N−1, ∥T∥ is a number of template samples, λₙ is a regularization parameter, and oₙ is a predefined value, or wherein o₀=1, oᵢ=0, or
wherein the error function is:
$$E = {\sum }_{‖ T ‖} {( {α}_{0} {Y}_{0} + {α}_{1} {Y}_{1} + {α}_{2} {Y}_{2} … + {α}_{N - 1} {Y}_{N - 1} + β - {X}_{0} )}^{2}$$
where X₀ is one sample in the first block template, Y₀ is a reference sample of X₀, Yᵢ has a predefined offset relative to Y₀, where i=1, 2, . . . , N−1, and ∥T∥ is a number of template samples.

11. The method of claim 1, wherein a direct current (DC) prediction is applied, and wherein for each sample in a second block, a corresponding virtual sample is derived using a mapping function, yielding a virtual block, and
wherein the mapping function is formed between samples in a reference block and a reference template, wherein the mapping function is used to map sample values in the second block to sample values in a current template which is neighboring to the second block, or wherein a DC of the virtual block is taken as a DC prediction of the second block.

12. The method of claim 11, wherein the mapping function is built based on a criterion between a sample in the reference block and a sample in the reference template, the criterion comprises minimum sum of absolute differences (SAD) and/or minimum sum of squared error (SSE), or
wherein when more than one samples in the reference template yields a same minimum cost for a sample in the reference block, a closest sample, which has a closest spatial distance to the sample in the reference block, of the more than one samples is selected, or
wherein a usage of the mapping function depends on coding information including a block size and/or a quantization parameter (QP).

13. The method of claim 1, wherein in a multi-model local illumination compensation (LIC), reference samples are classified into different subsets, and wherein a different LIC model is applied for each subset, wherein the LIC model for a subset is a two-parameter linear model or a multi-parameter linear model or a combination thereof, or wherein classification of the reference samples is based on a pre-defined threshold or clustering, or wherein the pre-defined threshold is explicitly signaled, or wherein selecting between an implicit threshold and an explicitly signaled threshold is employed, or
wherein when used with a geometric partition mode (GPM), classification of the reference samples is based on a partition of a template obtained by partitioning in the GPM, or wherein a usage of the multi-model LIC depends on coding information including a block size and/or a quantization parameter (QP).

14. The method of claim 1, wherein the bitstream includes a syntax element indicating whether a prediction mode is chosen for the first block, wherein the prediction mode is based on MPLIC model, wherein the prediction mode is based on direct current (DC) prediction, or wherein the prediction mode is based on multi-model local illumination compensation (LIC).

15. The method of claim 14, wherein the syntax element depends on at least one of: whether the first block is coded by an advanced motion vector prediction (AMVP) mode, whether the first block is coded by a merge mode, whether the first block is uni-predicted, whether the first block is bi-predicted, a type of merge prediction used, or
wherein when the first block is bi-predicted, the syntax element is inferred to be false, or
wherein the syntax element is signaled only for a subset or all of Y, U, V planes, or
wherein the syntax element is conditionally signaled, wherein signaling of the syntax element depends on at least one of: a dimension of the first block, a quantization parameter (QP) used to code the first block, or
wherein the syntax element is only signaled when the dimension of the first block is greater than, lower than, no greater than, or no lower than a pre-defined size, or wherein the syntax element is only signaled when a sum of width and height of the first block is greater than, lower than, no greater than, or no lower than a pre-defined threshold, or wherein the syntax element is only signaled when the QP for the first block is greater than, lower than, no greater than, or no lower than a pre-defined threshold, or
wherein the syntax element is binarized as a fixed length code, a truncated unary code, or an exponential Golomb code, or
wherein the syntax element is coded with at least one coding context in arithmetic coding, or
wherein the syntax element is coded with bypass coding.

16. The method of claim 1, wherein a usage of the method is signaled at a sequence level, a group of pictures level, a picture level, a slice level, or a tile group level, or
wherein the usage of the method is signaled in a sequence header, a picture header, a sequence parameter set (SPS), a video parameter set (VPS), a decoding parameter set (DPS), decoding capability information (DCI), a picture parameter set (PPS), an adaptation parameter set (APS), a slice header, or a tile group header, or
wherein the usage of the method is signaled at a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, and/or other kinds of region containing more than one sample or pixel, or
wherein application of the method is dependent on coded information including a block size, a color format, single tree partitioning, dual tree partitioning, a color component, a slice type, or a picture type.

17. The method of claim 1, wherein the conversion includes encoding the first block into the bitstream.

18. The method of claim 1, wherein the conversion includes decoding the first block from the bitstream.

19. An apparatus for processing video data, comprising:
a processor; and
a non-transitory memory with instructions thereon, wherein the instructions upon execution by the processor, cause the processor to:
determine to apply a multiple-parameter local illumination compensation (MPLIC) model to a first block of a video; and
perform a conversion between the first block and a bitstream of the video based on the MPLIC model.

20. A non-transitory computer-readable recording medium storing a bitstream of a video which is generated by a method performed by a video processing apparatus, wherein the method comprises:
determining to apply a multiple-parameter local illumination compensation (MPLIC) model to a first block of the video; and
generating the bitstream based on the MPLIC model.
